(19) United States
(12) Patent Application Publication
(10) Pub. No.: US 2024/0293283 A1
(43) Pub. Date: Sep. 5, 2024

(54) DEVICES AND METHODS FOR TREATING TESTICULAR PAIN

(71) Applicant: PathRight Medical, Inc., Plymouth, MN (US)

(72) Inventors: Raymond A. Bonneau, San Francisco, CA (US); David Aaronson, Hillsborough, CA (US)

(21) Appl. No.: 18/590,611

(22) Filed: Feb. 28, 2024

Related U.S. Application Data
(60) Provisional application No. 63/488,156, filed on Mar. 2, 2023.

(51) Int. Cl. A61H 23/02

(52) U.S. Cl. CPC A61H 23/02; A61H 2201/163; A61H 2201/165; A61H 2205/087

(57) ABSTRACT

The present disclosure relates to a method of treating testicular pain. The method of treating testicular pain includes identifying a location of testicular pain in a human subject, coupling a vibration mechanism to a pelvic region of the human subject based on an identified location of testicular pain, and applying vibrations to the pelvic region to alleviate testicular pain.

### CROSS-REFERENCE TO RELATED APPLICATION

The priority benefit of U.S. Provisional Application No. 63/488,156, filed Mar. 2, 2023, is hereby claimed and the entire contents are incorporated by reference.

### TECHNICAL FIELD

The present disclosure relates to devices and methods for treating testicular pain, and in particular, to devices and methods that apply vibration to a pelvic region to treat testicular pain.

### BACKGROUND

Testicular pain may be caused by a variety of injuries or disorders in men. For example, iliohypogastric neuralgia, ilioinguinal neuralgia, genitofemoral neuralgia, chronic groin pain, chronic testicular pain (CTP), post vasectomy pain, hypogastric nerve injury, anterior extrusions, and other pain originating from the testicles, groin, or abdomen are common reasons for referral to a urological specialist. The testicular pain experienced by a subject may be unilateral or bilateral, constant or intermittent, spontaneous or exacerbated by physical activities and pressure. Pain may remain localized in the scrotum or radiate to throughout the pelvic region to the groin or perineum, or extend to the back or legs.

### SUMMARY

According to the present disclosure, devices and methods for non-invasively treating testicular pain using vibrational massage may be adapted to a wide variety of physiologies of subjects to treat testicular pain.

In a first example aspect, a method of treating testicular pain may include identifying a location of testicular pain in a human subject, coupling a vibration mechanism to a pelvic region of the human subject based on an identified location of testicular pain, and applying vibrations to the pelvic region to alleviate testicular pain.

In a second example aspect, a method of treating testicular pain in a subject may include applying a vibration device to a pelvic region of the human subject. The vibration device may include a garment and a vibration mechanism coupled to the garment. The method may include identifying a target location to treat testicular pain in the pelvic region. The target location may be adjacent to one or more of a iliohypogastric nerve, a ilioinguinal nerve, and a genitofemoral nerve. The method may include positioning the vibration mechanism adjacent to the target location of the human subject, and delivering vibrations to the pelvic region at the target location of the human subject to treat testicular pain.

In a third example aspect, a wearable device for treating testicular pain in a subject may include a garment, a vibration mechanism comprising a vibratory element, a battery coupled to the vibratory element, and a controller operatively coupled to the vibratory element. The vibration mechanism may be configured for applying vibrations to a pelvic region of the human subject.

In accordance with any one of the first, second, and third example aspects, a method for treating testicular pain and a wearable stimulation device for treating testicular pain may include any one or more of the following forms.

In one form, applying vibrations may include applying vibrations to a testicular cord of the human subject.

In another form, applying vibrations may include applying vibrations to a cremasteric muscle of the human subject.

In some forms, applying vibrations may include applying vibrations to an inguinal canal of the human subject.

In other forms, applying vibrations may include applying vibrations to an ilioinguinal nerve of the human subject.

In yet another form, applying vibrations may include applying vibrations to an iliohypogastric nerve of the human subject.

In one example, applying vibrations may include applying vibrations to one or more of a genitofemoral nerve and a pudendal nerve of the human subject.

In some examples, coupling the vibration mechanism may include engaging the vibration mechanism with a scrotum of the human subject.

In another example, the method may include coupling a second vibration mechanism to another area of the pelvic region of the human subject.

In other examples, the method may include adjusting a frequency of the vibrations being applied, wherein the frequency is in a range of approximately 15 Hz to approximately 55 Hz.

In yet another example, applying the vibration device may include positioning a second vibration mechanism of the vibration device in a second target location of the pelvic region of the human subject.

In one aspect, applying the vibration device may include fastening a strap around the human subject.

In another aspect, the vibration mechanism may be supported by the strap.

In another aspect, applying the vibration device may include dressing the human subject with an undergarment.

In some aspects, the undergarment may be configured to support to the vibration mechanism.

In yet another aspect, the method may include inserting the vibration mechanism inside a pocket of the undergarment.

In some aspects, the method may include communicating with a controller using a remote communication device to adjust a frequency of a vibratory element of the vibration mechanism, wherein the controller is communicatively coupled to the vibratory element.

In other aspects, the vibration mechanism may include a second vibratory element.

In some forms, the controller may be configured to separately operate the vibratory element and the second vibratory element at different frequencies.

In one form, the garment may include a flexible band arranged for removably attaching to a pelvic region of the human subject.

In another form, the vibration mechanism may be coupled to the flexible band.

In other forms, a controller may be operatively coupled to the vibratory element.

In some forms, the controller may include a processor, a memory communicatively coupled to the processor and storing executable instructions that, when executed by the processor, causes the processor to receive data transmitted by a remote communication device, send a signal to the vibratory element, and adjust an intensity parameter of a vibration applied by the vibratory element.

### Definitions

As used herein, the terms “top,” “bottom,” “upper,” “lower,” “above,” and “below” are used to provide a relative relationship between structures. The use of these terms does not indicate or require that a particular structure must be located at a particular location in the apparatus.

Some examples may be described using the expression “coupled” and “connected” along with their derivatives. For example, some arrangements may be described using the term “coupled” to indicate that two or more elements are in direct physical or electrical contact. The term “coupled,” however, may also mean that two or more elements are not in direct contact with each other, but yet still co-operate or interact with each other. The examples described herein are not limited in this context.

As used herein, the term “pelvic region” or “pelvic/scrotal region” may be used to refer to right, left, or both sides of one or more of a lower pelvic region, scrotum, perineum, epididymis, vas deferens, testicle, testicular cord (or spermatic cord), cremasteric muscle(s), inguinal ring, inguinal canal, genitofemoral nerve, ilioinguinal nerve, iliohypogastric nerve, and pudendal nerve.

Examples of the present disclosure can include one or more of the following advantages.

The disclosed methods and devices may advantageously modulate the frequency or amplitude of vibrations coming into the targeted areas (e.g., the testicular cord, including the testicular cremasteric muscles, inguinal canal, ilioinguinal nerve, the iliohypogastric nerve, and/or iliohypogastric nerve) and downregulate the sensitivity of the spinal cord/brain of the subject, such that the normal pain signals coming in will no longer be sufficient to register as pain.

In some examples, the disclosed methods and devices may be used to treat scrotal pain, chronic pelvic pain, meralgia paraesthetica, and cramping discomfort of irritable bowel syndrome.

In some examples, the disclosed methods and devices may provide alternatives to pharmacologic and surgical therapies.

In some examples, the disclosed devices may be integrated with a wearable garment or accessory to provide a discreet device that is low profile and quiet.

In some examples, the disclosed methods and devices may exhaust the ability of the targeted nerves to fire, which can occur with repeated stimulation.

In some examples, the disclosed methods and stimulation devices may be adapted to treat a patient population having subjects in a wide range of weight classes and with scrotal lengths and sizes.

Other features and advantages of the present disclosure will be apparent from the following detailed description, figures, and claims.

### BRIEF DESCRIPTION OF THE DRAWINGS

FIG. 1 is a front view of a stimulation device coupled to a pelvic region of a human subject to treat testicular pain in accordance with the teachings of the present disclosure;

FIG. 2A is a front view of a user wearing another example stimulation device underneath a garment in accordance with the teachings of the present disclosure;

FIG. 2B is a cross-sectional side view of the stimulation device and garment of FIG. 2A;

FIG. 3A is a front view of a user wearing the stimulation device of FIG. 2A with a different garment;

FIG. 3B is a cross-sectional side view of the stimulation device and undergarment of FIG. 3A;

FIG. 4 is a front view of another example stimulation device coupled to a pelvic region of a human subject to treat testicular pain, and in communication with a personal electronic device in accordance with the teachings of the present disclosure;

FIG. 5 is a front view of a user wearing another example stimulation device in accordance with the teachings of the present disclosure;

FIG. 6 is a front view of another example stimulation device assembled in accordance with the teachings of the present disclosure; and

FIG. 7 is a schematic drawing of a control system that can be used to perform operations according to the teachings of the present disclosure.

### DETAILED DESCRIPTION

According to the present disclosure, devices and methods for non-invasively treating testicular pain using vibrational massage may be adapted to a wide variety of physiologies of subjects to treat testicular pain.

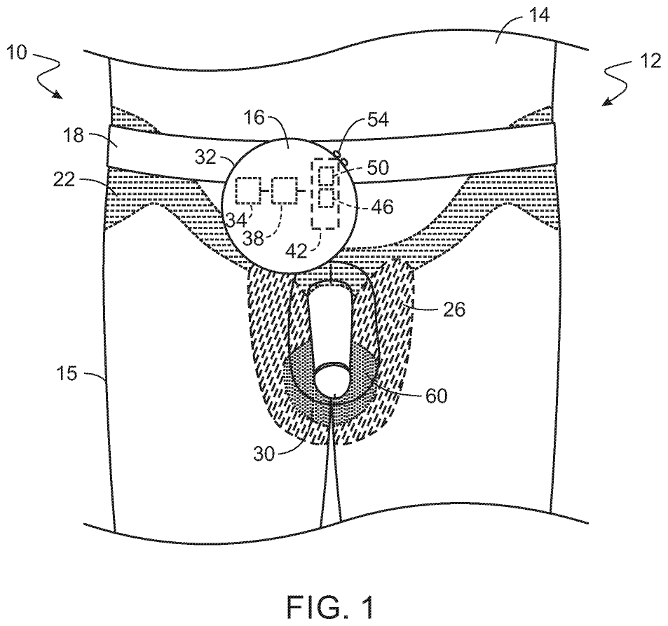

In FIG. 1, a first example stimulation device 10 is arranged for applying or delivering vibrations on or near a pelvic region 12 of a subject 14 to treat testicular pain. The stimulation device 10 includes a vibration mechanism 16 and an adjustable strap or belt 18. As shown FIG. 1, the belt 18 is attached around a waist or hips of a human subject 14, positioning the vibration mechanism 16 close to a iliohypogastric nerve 22 (shaded) on a right side of the subject's pelvic region 12. The user may lower the belt 18 or strap the belt 18 around the subject's thigh 15 to position the vibration mechanism 16 close to an ilioinguinal nerve 26 (shaded) or close to a genitofemoral nerve 30 (shaded). Vibrations may be applied to these target treatment areas 22, 26, 30 to deliver vibrational massage therapy to the pudendal nerve, spermatic cord, inguinal ring, inguinal canal, scrotum, testicular cord, and/or cremasteric muscles of the subject 14.

The vibration mechanism 16 is puck-shaped and can be positioned at any location on the belt 18 by sliding the vibration mechanism 16 relative to the belt 18 and/or by clipping the vibration mechanism 16 to the belt 18 at a desired location. The vibration mechanism 16 is fastened (e.g., clipped, snapped, buckled, hook-and-loop mated, etc.) to the belt 18 so that the vibration mechanism 16 is positioned in a desired target area of treatment. In some examples, the user may rotate the belt 18 relative to their body and vibration mechanism 16 to position the vibration mechanism 16 at a target area. In some examples, the vibration mechanism 16 is rotatable relative to the belt 18 to position the vibration mechanism 16 in a desired location. The vibration mechanism 16 may be used to apply vibration anywhere from an inguinal ring to the scrotum of a subject. For example, the vibration mechanism 16 may be adjusted vertically (relative to the orientation of FIG. 1) so that the belt 18 remains around the user's waist or hips while the vibration mechanism 16 is positioned at a lower portion of the subject's pelvic region. While not illustrated in FIG. 1, the vertical positioning of the vibration mechanism 16 may be adjusted using a retractable cord or additional strap that is coupled to the vibration mechanism 16. In another example, the belt 18 may be fastened to an upper thigh of the subject 14.

The vibration mechanism 16 is configured to apply a massage-like input to a target nerve, muscle, or tissue. The vibration mechanism 16 includes a housing 32, a vibratory element 34, a battery 38, and a controller 42. The vibratory element 34, battery 38, and controller 42 are disposed in the housing 32 and are electrically connected so that the controller 42 can operate the vibratory element 34 (e.g., via transmitters and receivers) and the battery 38 can provide power to the vibratory element 34 and the controller 42. In some examples, a retractable cord may be at least partially stored in the housing 32.

The vibratory element 34 is a DC motor that generates vibrations, such as an Eccentric Rotating Mass (“ERM”) vibration motor, which uses an unbalanced load to generate vibrations. However, in other examples, the vibratory element 34 may be a pancake or shaftless motor, a piezoelectric vibration generator, or other suitable means for producing vibrations. A location of the vibratory element 34 is schematically shown relative to the other components of the vibration mechanism 16, and is not limited to what is shown in the Figures. For example, in FIG. 1, the vibratory element 34 is illustrated to a left side of the vibration mechanism housing 32. However, in this or other examples, the vibratory element 34 may be placed at any location within the housing 32 (e.g., closer to any of the outer surfaces of the housing, or evenly spaced between two or more surfaces of the housing).

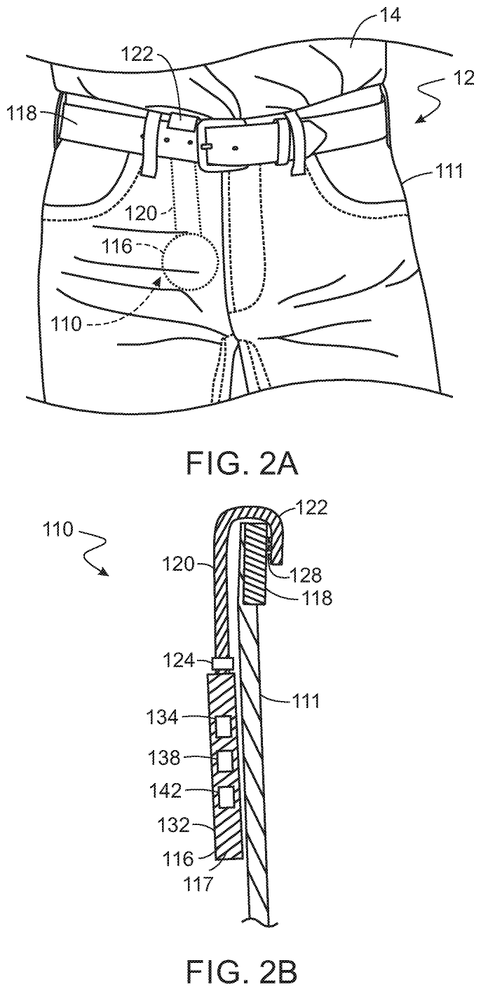

The housing 32 is a thin, pliable membrane capable of protecting the internal components from sweat, while also delivering vibrations to the subject. One or more layers of material (e.g., material 117 in housing 132 of FIG. 2B) may be disposed in the housing 32 that contribute (e.g., amplify, dampen, etc.) to a particular vibration massage or treatment. The housing 32 may be composed of and/or contain materials that are both capable of transmitting vibrations generated by the vibratory element 34 to the target treatment area of the subject 14 while also achieving a desirable feature, such as, for example, comfort, noise reduction, intensity, etc. For example, soft and pliable materials such as foam, cloth, or gel may be disposed between the vibratory element 34 and the subject 14, and that transmit vibrations while remaining comfortable to the subject 14. Increasing thickness of materials of the housing 32 or of materials disposed in the housing 32, for example, may reduce intensity and/or noise of the vibrations. Alternatively, reducing thickness of the materials of the housing 32 or of materials disposed in the housing 32, for example, may increase intensity and reduce the profile of the device 10. In some examples, an intensity of the vibrations may be modified by changing the shape of the housing 32 at the point of contact with the subject's body. In some examples, the housing 32 may be a silicone, plastic, or rubber material. In the illustrated example, the housing 32 is round with smooth surfaces. However, in other examples, the housing 32 may be another shape with textured or bumpy surfaces.

The battery 38 may be a rechargeable or non-rechargeable battery. In some examples, the device 10 is powered by other means.

The belt 18 is adjustable to accommodate different body sizes and different body parts. The belt 18 may be a pliable or stretchy material.

The control system 42 can communicate through signals (e.g., wired or wirelessly) to one or more components of the device 10. The controller 42 includes a processor 46 and a memory 50 that stores executable instructions that, when executed by the processor 46, can control certain settings (e.g., enable features, disable features, active mode, sleep mode, etc.) and energy parameters (e.g., frequency, intensity, time of delivery, delivery modes, etc.) of the stimulation device 10. For example, treatment parameters may be adjusted to provide vibrations having a desired intensity, frequency, and duration. In some aspects, control system 42 is a micro-processor based control system (or controller) that includes, e.g., hardware processor(s), memory module(s), and instructions executable as software code to cause the processor(s) to perform operations to control one or more components of the device 10. A plurality of buttons 54 are configured to receive input to operate and control the vibration mechanism 16. In some examples, the controller 42 may be operated (e.g., switch the device on or off, adjust vibration intensity, adjust vibration timing, etc.) by pressing one or more of the buttons 54. However, the control system 42 can also be realized as a mechanical, electro-mechanical, hydraulic, pneumatic, or other form of a control system or controller without departing from the scope of this disclosure.

The buttons 54 partially extend outside of the housing 32 for user interaction, and are configured to transmit a variety of different signals to the controller 42 to operate the stimulation device 10. For example, one or more buttons 54 may be pressed to turn on/off the device 10, increase or decrease a treatment parameter (e.g., intensity, frequency, time, etc.), or to adjust or program various settings of the stimulation device 10 (e.g., duration of delivering vibrations, setting alarms, providing modes, or programming treatment plans). In some examples, one or more dials, knobs, switches, may be used with or instead of the buttons 54 to operate the device 10.

In other examples, the housing 32 may include a user interface (e.g., a display screen, touchscreen, etc.) instead of or in addition to buttons 54 for operating and/or adjusting the treatment parameters and settings of the stimulation device 10. For example, a subject 14, caregiver, or healthcare provider may adjust the treatment parameters and settings of the stimulation device 10 through a personal electronic device, such as a smartphone, smartwatch, laptop, or other remote computer that can communicate wirelessly (e.g., via Bluetooth) with the controller 42 housed in the housing 32. In some examples, the healthcare provider may monitor the subject's usage of the device and adjust the treatment parameters from a remote location.

For example, the stimulation device 10 can be adjusted by the subject 14, caregiver, or healthcare provider to a desired frequency or shift in frequency (e.g., gradual change or shift between two or more frequencies), duration (e.g., time of the entire treatment, time of applying vibrations, time of rest, and combination thereof), amplitude, and mode (e.g., burst, continuous, intermittent, or other pattern) in accordance with a treatment plan and/or a comfort level of the subject 14. The vibrational frequency may be selected from a range of approximately 10 Hz or more (e.g., about 15 Hz or more, about 20 Hz or more, about 25 Hz or more, about 30 Hz or more, about 35 Hz or more, about 40 Hz or more, or about 45 Hz) to approximately 100 Hz or less (e.g., about 95 Hz or less, about 90 Hz or less, about 85 Hz or less, about 80 Hz or less, about 75 Hz or less, about 70 Hz or less, about 65 Hz or less, about 60 Hz or less, about 55 Hz or less, about 50 Hz or less, or about 45 Hz).

An example treatment plan may include applying a vibration at a lower frequency for a period of time, and gradually or periodically, increasing the frequency. Another example treatment may include applying intermittent vibrations so that the vibration mechanism 16 applies vibrations at a first frequency for a first time period, and stops for a second time period, and applies vibrations at the first or different frequency for a third time period after rest. Another example treatment may be fully customizable by the subject.

To treat testicular pain in the subject 14, a healthcare provider may first identify a location of testicular pain. After identifying the location of pain, the healthcare provider can recommend a target treatment area or location on the pelvic region 12 to treat the identified location of testicular pain. In some examples, the area or location of pain may be in a different area or location than the target treatment area or region. The device 10 is then attached to the subject 14 by fastening the belt 18 around the subject 14, and coupling the vibration mechanism 16 to the pelvic region 12 so that the vibratory element 34 can apply vibrations to the target treatment area. Once in place, the device 10 can be switched on, either wirelessly or locally via the buttons 54, and a vibrational treatment program can be started. The subject 14 or caregiver can adjust the treatment parameters to operate and manage a vibrational massage treatment plan as needed. The stimulation device 10 can operate for a predetermined duration at one or more frequencies, e.g., 5 minutes at 25 Hz, 5 minutes at 50 Hz, etc. One or more vibrational treatment programs may be stored in the memory 50 of the processor 46 can be accessed and adjusted.

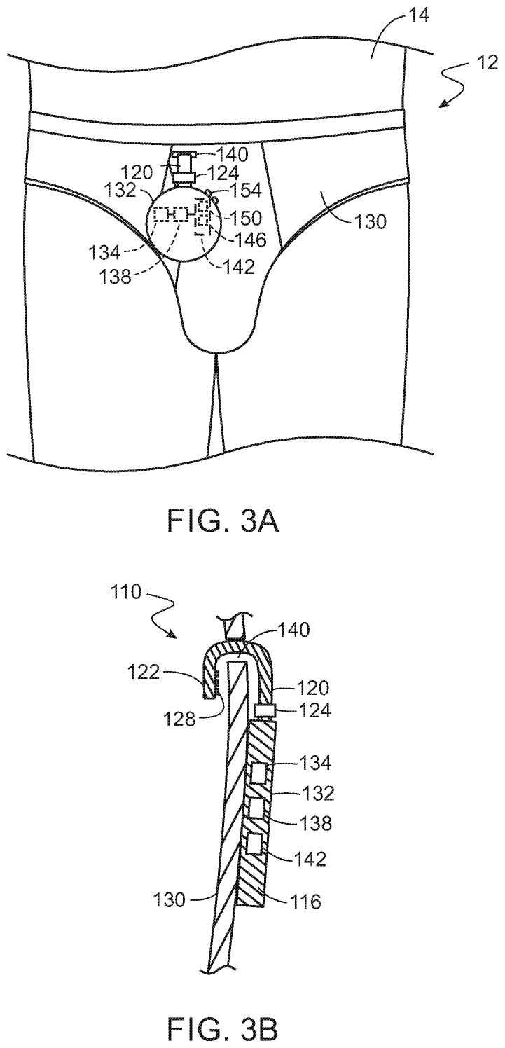

While the stimulation device 10 of FIG. 1 has been described as having a strap or belt 18, in some examples, a stimulation device may include a strap that hooks onto a subject's garment, as shown in FIGS. 2A-3B.

Referring to FIGS. 2A and 2B, a second example stimulation device 110 includes a vibration mechanism 116 for applying vibrations to a pelvic region 12 of a subject 14 to treat testicular pain. The second example stimulation device 110 is similar to the first example stimulation device 10 of FIG. 1. Thus, for ease of reference, and to the extent possible, the same or similar components of the second example device 110 will retain the same reference numbers as outlined above with respect to the first example device 10, although the reference numbers will be increased by 100. However, the second example device 110 differs from the first example device 10 in the manner discussed below.

In FIGS. 2A and 2B the device 110 is configured to be worn under a garment 111 and is attached to a waistband of the garment 111 or a belt 118. The vibration mechanism 116 of the device 110 is coupled to a strap 120, and is interiorly placed relative to the garment 111 worn by the subject 14. The strap 120 has an adjustment mechanism 124 that allows the strap 120 to extend or contract based to a desired length. At a distal end 122, the strap 120 forms a hook so that an underside surface of the hook engages an exterior surface of the belt 118 or waistband of the garment 111 and secures the device 10 to the subject's clothing. The underside of the hook 122 has a grippable surface 128 that securely adheres the strap 120 to the garment 111 and/or belt 118, but is configured for easily disengaging from the garment 111 and/or belt 118 to reposition or remove the device 110. The vibration mechanism 116 may be placed directly on the skin of the subject, or may be between a layer of material and the garment 111.

In FIGS. 3A and 3B, the stimulation device 110 is paired with a different garment 130, such as underwear, and is configured to apply vibrations over a layer of clothing. In this example, the garment 130 includes a reinforced opening 140 that is sized to receive the distal end 122 of the strap 120 to hook onto the undergarment 130. In this example, the garment 130 is configured for treating testicular pain on a right side of the subject 14. In other examples, the garment 130 may be configured for treating testicular pain on a left side of the subject 14 by providing a reinforced opening on the left side of the garment 130. In some examples, the garment 130 may include two or more openings for repositioning the device 10 as needed.

While the stimulation device 110 shown in FIGS. 2B and 3B have been illustrated as having the vibratory element 134 centrally disposed in the housing between parallel sides, in other examples, the vibratory element 134 may be disposed closer to one side of the housing 132. In this example, engaging this one side of the housing with the subject may apply stronger vibrations than engaging the other side of the housing with the subject. In other examples, the vibration mechanism 116 may include a first vibratory element 134 adjacent to one side of the housing and a second vibratory element 134 adjacent to the other side of the housing. In this case, either side or surface of the housing can be coupled to (or engaged with) the subject to apply vibrations interchangeably.

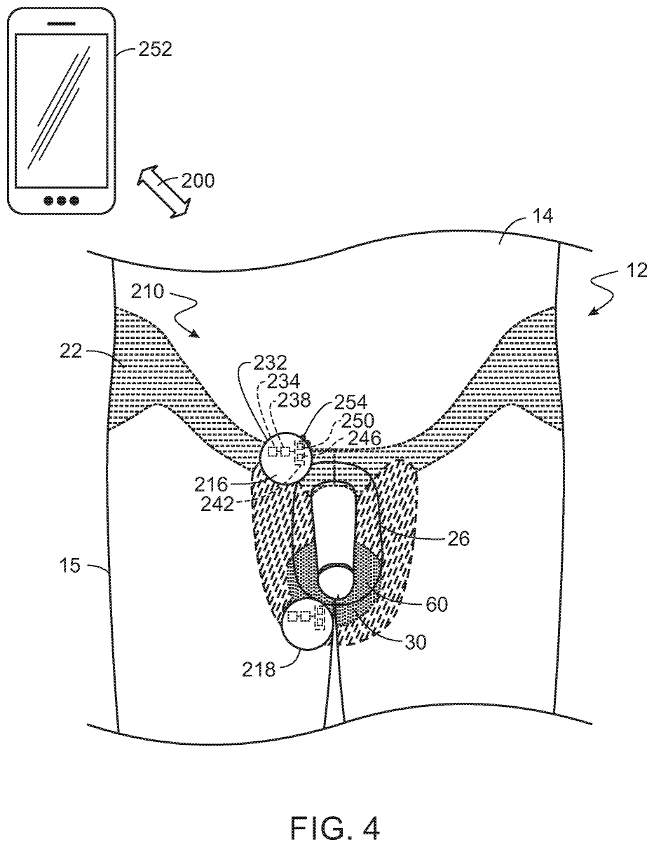

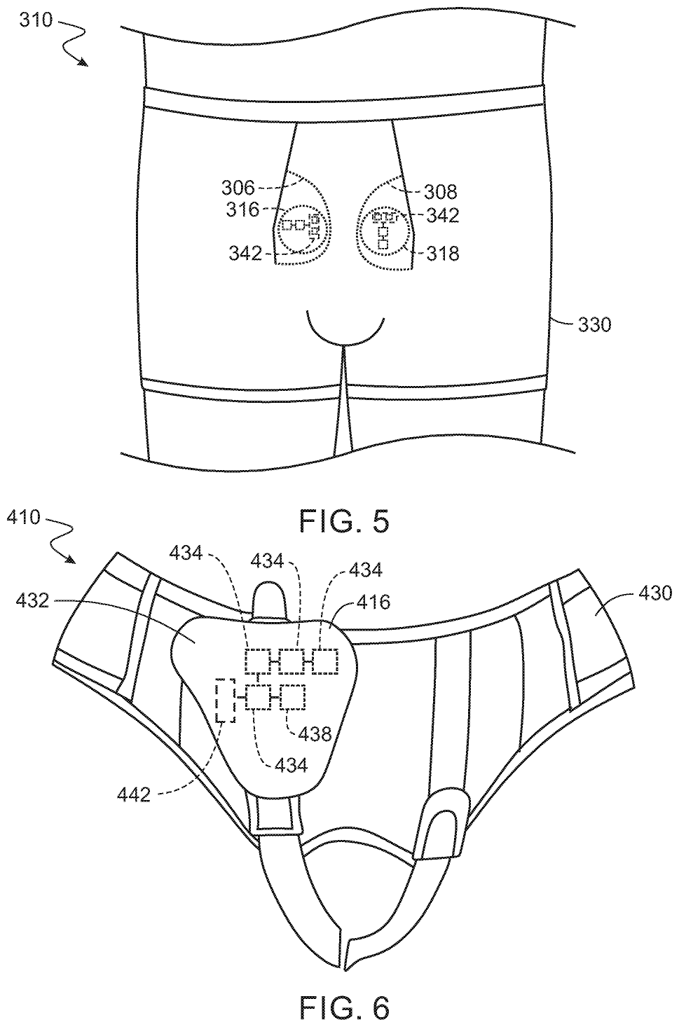

While the stimulation devices 10, 110 of FIGS. 1-3B have been described as having a single vibration mechanism 16, 116, in some examples, a stimulation device may include more than one vibration mechanism, as shown in FIGS. 4 and 5.

While the stimulation devices 10, 110 of FIGS. 1-3B have been described as having a vibration mechanism 16, 116 that hangs from a belt or strap, in some examples, a stimulation device may adhere directly to a subject's skin, as shown in FIG. 4.

Referring to FIG. 4, a third example stimulation device 210 includes two vibration mechanisms 216, 218 for applying vibrations to a pelvic region 12 of a subject 14 for treating testicular pain. The third example stimulation device 210 is similar to the first example stimulation device 10 of FIG. 1. Thus, for ease of reference, and to the extent possible, the same or similar components of the third example device 210 will retain the same reference numbers as outlined above with respect to the first example device 10, although the reference numbers will be increased by 200. However, the third example device 210 differs from the first example device 10 in the manner discussed below.

The stimulation device 210 includes two, separate vibration mechanisms 216, 218 that can be placed in any of the target treatment areas 22, 26, 30 of the subject's pelvic area 12. In the illustrated example, the first vibration mechanism 216 is placed on a right side of the pelvic area 12, and close to the iliohypogastric nerve 22, and the second vibration mechanism 218 is placed below the scrotum 60 and close to the genitofemoral nerve 30. Each vibration mechanism 216 has a contact surface that is configured to adhere to a skin surface of the subject 14. The contact surface may include a textured surface, adhesive, or other material that is configured for self-adhering or otherwise attaching to a skin surface securely (e.g., by suction or friction). Additionally, the contact surface may be removed and reattached to a skin surface repeatedly. In some examples, the contact surface may be a replaceable adhesive.

Each of the vibration mechanisms 216, 218 includes a vibratory element 234, a battery 238, and a controller 242. Accordingly, the vibration mechanisms 216, 218 can be programmed to apply different vibrational massage treatments to the different areas of the pelvis 12. The vibration mechanisms 216, 218 may also be programmed to apply the same vibrational massage treatment.

The vibration mechanisms 216, 218 may be coupled to the subject 14 at a combination of locations to best stimulate the testicular cord, including the testicular cremasteric muscles, inguinal canal, ilioinguinal nerve, the iliohypogastric nerve, and/or iliohypogastric nerve of the subject 14. It will be appreciated that the vibration mechanisms 216, 218 may be attached to any area of the pelvic region 12, such as, for example, along a circumference and length of the scrotum 60.

Each vibration mechanism 216, 218 of the stimulation device 210 may include one or more vibratory elements 234 that can be activated or deactivated depending on the treatment plan to treat testicular pain. In some examples, the controller 242 of each vibration mechanism 216, 218 may be configured to selectively adjust the treatment parameters for each vibratory element 234. For example, if a first area of the pelvic region requires more intense treatment than a second treated area, the user can adjust the parameters and/or settings of the vibratory elements 234 so that the first vibratory element 216 delivers an intense massage vibration treatment to the first region and the second vibratory element 218 delivers a less intense massage vibration treatment.

The stimulation device 210 can be operated using a personal electronic device 252, such as a smartphone, smartwatch, laptop, or other remote computer, as shown FIG. 4. An application stored on the personal electronic device 252 can be used to program and operate the device 210. Using wireless communication, such as via Wi-Fi, the subject 14 can control the device 210 remotely via wireless communication signals 200 rather than operating the device 210 manually (e.g., pressing buttons 254 through the housing 232). In the illustrated example of FIG. 4, the subject 14 can use an application stored on the personal electronic device 252 to operate the stimulation device 210. For example, the subject 14 can adjust the settings and parameters of the stimulation device 210 to deliver a particular stimulating treatment to the pelvic region 12. The application may also be programmable so that the subject can create and store a treatment plan for repeated use. The application may also be remotely accessed by a health care provider so that the health care provider can adjust the parameters and/or settings of the device 210, and create and/or modify treatment programs customized for the subject 14. Any of the stimulation devices 10, 110, 210, 310, 410 described herein can be configured for operation by a personal electronic device via a wireless (e.g., Bluetooth) connection.

While the stimulation device 210 of FIG. 4 has been described as having two separate and independently controlled vibration mechanisms 216, 218, in other examples, a stimulation device may include two or more vibration mechanisms that are connected and do not operate independently.

While the stimulation devices 10, 110, 210 of FIGS. 1-4 have been described as being worn either under a garment or over a garment, in some examples, a stimulation device may include a vibration mechanism that is embedded between one or more layers of a garment, as shown in FIG. 5.

Referring to FIG. 5, a fourth example stimulation device 310 includes two vibration mechanisms 316, 318 coupled to a garment 330 for applying vibrations to a pelvic region 12 of a subject 14 for treating testicular pain. The fourth example stimulation device 310 is similar to the third example stimulation device 210 of FIG. 4. Thus, for ease of reference, and to the extent possible, the same or similar components of the fourth example device 310 will retain the same reference numbers as outlined above with respect to the third example device 210, although the reference numbers will be increased by 100. However, the fourth example device 310 differs from the third example device 210 in the manner discussed below.

In FIG. 5, a wearable device 310 includes a garment 330, which in this example is underwear, and two vibration mechanisms 316, 318. The undergarment 330 has two built-in pockets 306, 308, each sized to receive one of the vibration mechanisms 316, 318. The subject 14 may wear and easily operate the stimulation device 310 throughout the course of a day. For example, the user can retrieve one or more of the vibration mechanisms 316, 318, operate it (e.g., turn on/off, adjust vibration parameters via the buttons), and insert the one or more vibration mechanism 316, 318 back into the pockets 306, 308. In other examples, the undergarment 330 may include more or fewer pockets. For example, the underwear pouch that covers a subject's penis and scrotum may include a plurality of vibratory elements that can be selectively operated to deliver vibrations to various locations of the pelvic region. In another example, the pockets 306, 308 may be large enough to receive two or more vibration mechanisms.

While the stimulation device 310 of FIG. 5 has been described as having two vibration mechanisms 316, 318, in other examples, a wearable stimulation device may include one or more than two vibration mechanisms that fit into a corresponding number of pockets disposed in the same or different areas relative to the pelvic region of the garment. In other examples, the vibration mechanisms may be sewn into the undergarment for permanent fixation.

While the vibration mechanisms 16, 116, 216, 218, 316, 318 of the stimulation devices of FIGS. 1-5 have been depicted or described as smooth-surfaced pucks, in other examples, a vibration mechanism may have a different shape and the housing may have different surface treatment. For example, a vibration mechanism 416 of FIG. 6 has a non-circular shape.

While the vibration mechanisms 16, 116, 216, 218, 316, 318 of the stimulation devices 10, 110, 210, 310 of FIGS. 1-5 have been described as having one vibratory element 34, 134, 234, 334, in other examples, a vibration mechanism of a stimulation device may have two or more vibratory elements disposed in a housing. In some examples, the stimulation device may include a network of vibratory elements or mechanisms that can be individually or cooperatively controlled. For example, the vibration mechanism 416 of FIG. 6 includes a plurality of vibratory elements 434 disposed in the housing 432.

Referring to FIG. 6, a fifth example stimulation device 410 includes a harness 430 coupled to a vibration mechanism 416 for applying vibrations to a pelvic region 12 of a subject 14 to treat testicular pain. The fifth example stimulation device 410 is similar to the fourth example stimulation device 310 of FIG. 5. Thus, for ease of reference, and to the extent possible, the same or similar components of the fifth example device 410 will retain the same reference numbers as outlined above with respect to the fourth example device 310, although the reference numbers will be increased by 100.

The vibration mechanism 416 is removably attached to the harness 430 by a fastening device (e.g., clip, hook-and-loop mating, snaps, etc.). The vibration mechanism 416 includes a network of vibratory elements 434 that share electrical power with one another. A controller 442 is communicatively coupled to two or more of the vibratory elements 434 so that the vibratory elements can be programmed to emit vibrations in unison, independently, intermittently, in a selected order, in a staggered order, and/or at the same or different frequencies.

While the vibration mechanism 416 of the device of FIG. 6 is described as having vibratory elements 434 that share electrical power with one another, in other examples, the vibratory elements 434 may be connected to separate batteries within the housing.

While the controller 442 of the device 410 is described as being coupled to each vibratory element 434 separately, in other examples, the controller 442 may be coupled to only one vibratory element, which in turn is coupled to the other vibratory elements, so that the controller operates the vibratory elements in unison.

While the stimulation devices 110, 310, 410 of FIGS. 2A-3B, 5, and 6 are coupled to, or embedded in, garments (e.g., pants, underwear, belts, harness), in other examples, the stimulation device may be incorporated in different wearable items. In other examples, the stimulation device may be a handheld device.

In some examples, the stimulation devices 10, 110, 210, 310, 410 may incorporate heating or cooling elements that can be operated to deliver heat or a cooling sensation in addition to or instead of applying vibrations. In some examples, the vibratory element of the vibration mechanism is configured to emanate heat or a cooling sensation while applying vibrations.

With reference to FIGS. 1-6, an example operation of the stimulation device 10 can be performed to treat testicular pain. One or more steps of the example operation can be performed by or with the control system 42, 142, 242, 342, 442 (e.g., with input from a human operator). For instance, the operation can include adjusting a pulse intensity, setting a timer for treatment, sending results to a healthcare provider, etc.

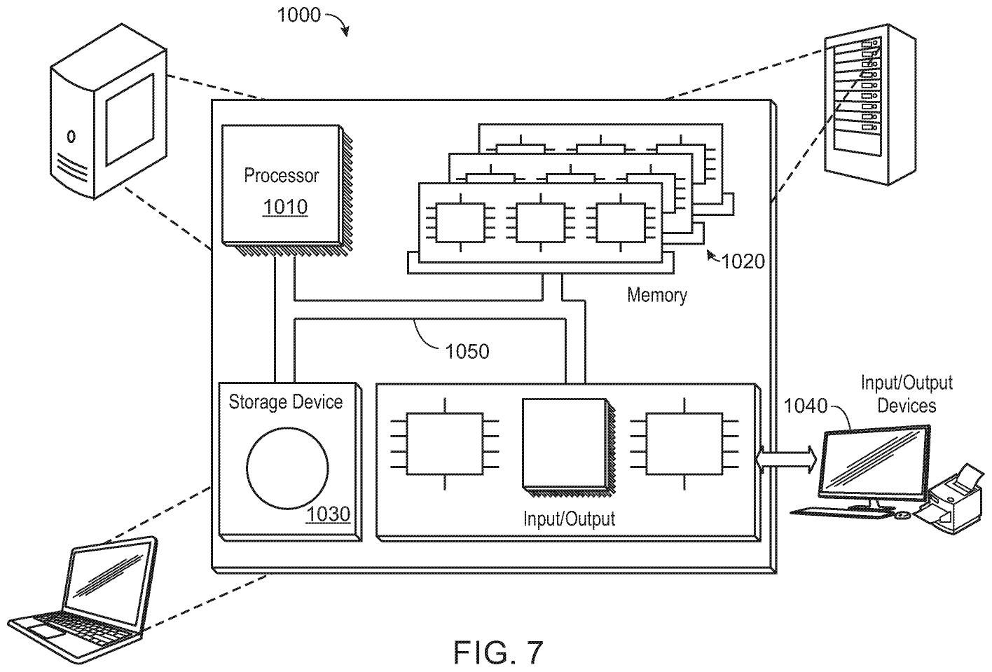

FIG. 7 shows a schematic drawing of a control system 1000 that can be used, e.g., as control system 42, 142, 242, 342, 442 to perform operations according to the present disclosure. Some or all of the example control system 1000 can be implemented as cloud-based system and/or service, alone or in combination with other portions of the example control system 1000 that can be implemented to execute. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the control system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, a tape device, flash memory, a solid state device (SSD), or a combination thereof.

The input/output device 1040 provides input/output operations for the controller 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of treating testicular pain, the method comprising:
identifying a location of testicular pain in a human subject;
coupling a vibration mechanism to a pelvic region of the human subject based on an identified location of testicular pain; and
applying vibrations to the pelvic region to alleviate testicular pain.

2. The method of claim 1, wherein applying vibrations comprises applying vibrations to a testicular cord of the human subject.

3. The method of claim 1, wherein applying vibrations comprises applying vibrations to a cremasteric muscle of the human subject.

4. The method of claim 1, wherein applying vibrations comprises applying vibrations to an inguinal canal of the human subject.

5. The method of claim 1, wherein applying vibrations comprises applying vibrations to an ilioinguinal nerve of the human subject.

6. The method of claim 1, wherein applying vibrations comprises applying vibrations to an iliohypogastric nerve of the human subject.

7. The method of claim 1, wherein applying vibrations comprises applying vibrations to one or more of a genitofemoral nerve and a pudendal nerve of the human subject.

8. The method of claim 1, wherein coupling the vibration mechanism comprises engaging the vibration mechanism with a scrotum of the human subject.

9. The method of claim 8, comprising coupling a second vibration mechanism to another area of the pelvic region of the human subject.

10. The method of claim 1, comprising adjusting a frequency of the vibrations being applied, wherein the frequency is in a range of approximately 15 Hz to approximately 55 Hz.

11. A method of treating testicular pain in a human subject, the method comprising:
applying a vibration device to a pelvic region of the human subject, the vibration device comprising a garment and a vibration mechanism coupled to the garment;
identifying a target location to treat testicular pain in the pelvic region, wherein the target location is adjacent to one or more of a iliohypogastric nerve, a ilioinguinal nerve, and a genitofemoral nerve;
positioning the vibration mechanism adjacent to the target location of the human subject; and
delivering vibrations to the pelvic region at the target location of the human subject to treat testicular pain.

12. The method of claim 11, wherein applying the vibration device comprises positioning a second vibration mechanism of the vibration device in a second target location of the pelvic region of the human subject.

13. The method of claim 11, wherein applying the vibration device comprises fastening a strap around the human subject, wherein the vibration mechanism is supported by the strap.

14. The method of claim 11, wherein applying the vibration device comprises dressing the human subject with an undergarment, wherein the undergarment is configured to support to the vibration mechanism.

15. The method of claim 14, comprising inserting the vibration mechanism inside a pocket of the undergarment.

16. The method of claim 11, comprising communicating with a controller using a remote communication device to adjust a frequency of a vibratory element of the vibration mechanism, wherein the controller is communicatively coupled to the vibratory element.

17. A wearable device for treating testicular pain in a human subject, the wearable device comprising:
a garment;
a vibration mechanism comprising a vibratory element, a battery coupled to the vibratory element, and a controller operatively coupled to the vibratory element,
wherein the vibration mechanism is configured for applying vibrations to a pelvic region of the human subject.

18. The wearable device of claim 17, wherein the vibration mechanism comprises a second vibratory element, and wherein the controller is configured to separately operate the vibratory element and the second vibratory element at different frequencies.

19. The wearable device of claim 17, wherein the garment comprises a flexible band arranged for removably attaching to a pelvic region of the human subject, wherein the vibration mechanism is coupled to the flexible band.

20. The wearable device of claim 17, comprising a controller operatively coupled to the vibratory element, the controller comprising a processor, a memory communicatively coupled to the processor and storing executable instructions that, when executed by the processor, causes the processor to:
receive data transmitted by a remote communication device;
send a signal to the vibratory element;
adjust an intensity parameter of a vibration applied by the vibratory element.
